(19) United States
(12) Patent Application Publication
(10) Pub. No.: US 2004/0207857 A1
(43) Pub. Date: Oct. 21, 2004

(54) Optical sharpness meter

(76) Inventor: Robert C. Lebeau, Vacaville, CA (US)

Correspondence Address: WILLIAM S. BERNHEIM, 255 N. Lincoln Street, Dixon, CA, 95620, US

(21) Appl. No.: 10/413,671

(22) Filed: Apr. 16, 2003

(51) Int. Cl. G01B 11/24

(52) U.S. Cl. 356/601

(57) ABSTRACT

An optical sharpness meter for measuring and quantifying the degree of sharpness at points along a blade by directing a light at the sharpened edge and measuring the intensity of the reflected light which varies with the sharpness.

### BACKGROUND OF THE INVENTION

1. Field of the Invention

This invention relates generally to devices useful for evaluating the degree of sharpness of sharp edges such as blades.

2. Description of the Prior Art

It is generally held that the ideal sharp edge exists where two planes meet with zero radius. In reality, however, there will be always a radius to an edge. The smaller the radius, the sharper the edge. The radius is typically minimized by suitable sharpening.

There are a large number of aspects that determine the performance of devices with sharp edges, including knives, blades, chisels and the like. Sharp edge geometry and texture are primary factors affecting sharpness. Many popular techniques for evaluating sharpness include experimentally cutting varying types of material, and/or the comparative cutting of one type of material by differing edges. Analysis of these methods reveals that these tests reflect the cutting ability of the sharp edge but not necessarily the sharpness of the edge. Problematically, other factors such as sharp edge design, sharp edge balance, or personal bias can affect the test results, leading to a large degree of variability. In other words, by means of the above mentioned tests the overall ability of the sharp edge to cut is reflected, but no information is provided as to the uniformity of the blade's edge, location of dull points, i.e. burrs, dents, flat spots and the like. Consequently, by means of known cutting tests a quantitative measurement of sharpness is done for the whole blade or large parts of the blade, which is difficult or impossible to translate into a prescription for how much to sharpen the edge and precisely where on the edge to perform the sharpening. Complicating the lack of localized information as to edge sharpness, most popular sharpening tools are abrasive devices, which require maintaining a predetermined bevel angle throughout the sharpening process along the entire blade length, with no means inherent for differentiating between dull and sharp zones of the edge. Consequently, the detection and determination of edge sharpness by known evaluation techniques, and the sharpening of edges by present sharpening methods results in the need to sharpen blades along the whole length of the blade length, including adequately sharp zones of the edge. Resultantly, blade life and attractiveness is decreased, and cost and maintenance efforts are increased. Therefore, it can be appreciated that there exists a need for sharpness meter capable of reliably and readily providing a quantitative and localized measurement of sharpness of sharp edges.

### SUMMARY OF THE INVENTION

The optical sharpness meter of the present invention departs substantially from conventional designs and concepts of prior art. In doing so it provides an apparatus and method primarily developed to evaluate the sharpness of an edge and provide a quantitative unbiased measurement including degree of sharpness for an edge. Importantly, it also evaluates and provides information regarding the degree of sharpness at different locations along the edge.

To attain this, the present invention includes a light-impermeable main body or housing with a slide receptor for a blade or other sharp edge being measured. A light source, a light meter including (i) a light receptor, (ii) a light measuring chip and (iii) a digital read out positioned inside the main body and powered by a power supply positioned within or outside the housing. The light source is positioned in such a way that it emits a light beam under an angle toward the sharp edge being measured. Light from the light source reflects from the edge of the blade or other sharp edge, and is detected by the light meter and quantified in terms of intensity and concentration relative to the originally emitted light beam. The greater or lesser the intensity, the more dull or more sharp the edge.

It is an object of the present invention to provide a reliable and cost-effective apparatus and method for quantitative measurement of the sharpness of an edge.

It is further object of this invention is to provide reliable and cost-effective quantitative measurement of the sharpness of an edge at different locations of an edge.

### BRIEF DESCRIPTION OF THE DRAWINGS

FIG. 1 is a diagram of the present invention showing relative positions of cooperating parts of the optical sharpness meter of the present invention

FIG. 2 is a block diagram illustrating connection to a control unit of various components of the optical sharpness meter of the present invention.

### DESCRIPTION OF THE PREFERRED EMBODIMENT

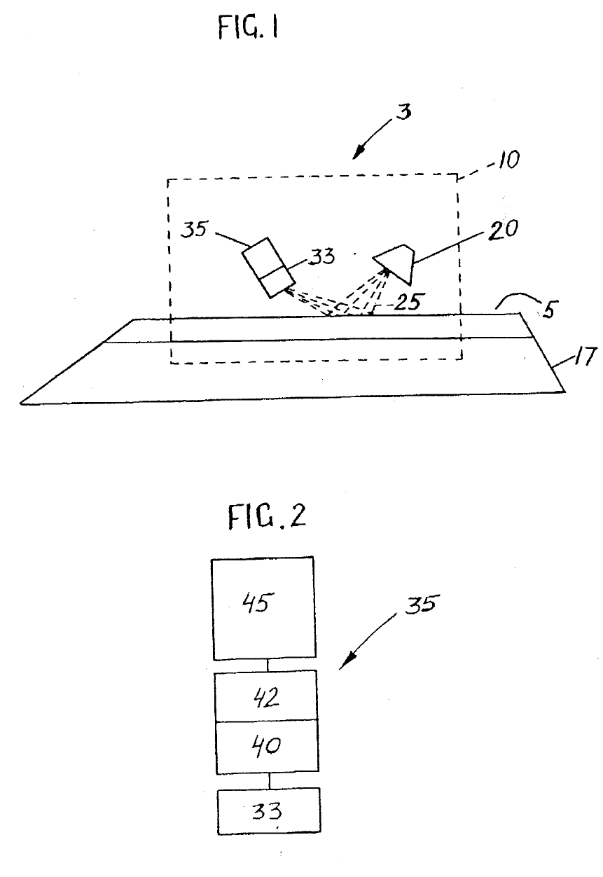

As shown in FIG. 1, optical sharpness meter 3 has light-impermeable main body or housing 10, and includes a fixed slide-in receptor slot for within which is received and disposed the sharp edge being measured. The slide-in receptor slot is designed and configured so as to position the cutting edge 5 of a blade 17 or other sharp edge being measured in a predetermined and preferably static position. The slid-in receptor slot is relatively light impermeable when the sharp edge being measured is positioned in the slot. The sharp edge can be hand held and moved along the slide-in receptor 13. Inside the housing is located a light source 20 that emits rays of light 25 directed at an angle generally toward the apex of the sharp edge being measured. Because in the theoretical, but not existing perfectly sharp edge there exists no radius at the meeting of the two planes ultimately defining the sharp edge, reflection of light from a perfectly sharp edge is impossible. However, the more dull or more imperfect the sharp edge, the greater the radius and correspondingly the surface present for reflection of light. Resultantly, the duller the blade the more light is reflected. Nicks, chips, burrs and any deformities on the edge will also create additional surface for light reflection, leading to a greater magnitude of reflected light. A light receptor 33 is positioned substantially symmetrical to light source 20 with the generally predetermined position of the apex of the sharp edge under measurement generally defining the point of symmetry from which light source 20 and light receptor 33 are symmetrically offset. The orientation of light source 20 and light receptor 33 relative to one another is such that light both emitted from light source 20 and reflected off any surface of the sharp edge being measured impacts light receptor 33.

As shown in FIG. 2, light meter 35 includes light receptor 33, control unit 40, power unit 42, and visual display 45. The magnitude of light reflected from the sharp edge being measured is detected and metered by light meter 35. Light receptor 33 is cooperatively coupled to control unit 40. Control unit 40 can be implemented utilizing programmed general purpose processors, application specific processors, firmware and discrete components or combination thereof. Upon being activated and receiving from light receptor 33 a LIGHT signal and a MAGNITUDE signal, control unit 40 preferably generates a signal and activates visual display 45 so as to indicate to a viewer the magnitude of light detected in scalar form, preferably on a digital readout.

I claim:

1. An optical sharpness meter for measuring and quantifying the degree of sharpness of an edge comprising:
a) a light source for generating a light beam directed under an angle onto the edge being measured;
b) a light meter for collecting light reflected from the edge being measured and capable of converting the intensity of reflected light into an assessable form; and
c) a power source

2. The optical sharpness meter of claim 1 further comprising a visual display indicating the degree of sharpness of the edge being measured.

3. The optical sharpness meter of claim 1 further comprising a light-impermeable housing.

4. The optical sharpness meter of claim 1 further comprising a slide receptor for positioning the edge being measured.

5. A method for measuring and quantitatively assessing the sharpness of an edge comprising the following steps:
a) generating a light beam directed toward the edge; and
b) detecting the amount of the light reflected from the edge;

6. The method of claim 5 for measuring and quantitatively assessing the sharpness of an edge further comprising the additional step of converting the amount of reflected light into a visual display indicating degree of sharpness of the edge being measured.
